(19) United States
(12) Patent Application Publication
(10) Pub. No.: US 2018/0292216 A1
(43) Pub. Date: Oct. 11, 2018

(54) METHOD, DEVICE AND SYSTEM FOR DETERMINING AN INDOOR POSITION

(71) Applicant: SIEMENS AKTIENGESELLSCHAFT, München (DE)

(72) Inventors: Moises Enrique Jimenez Gonzalez, München (DE); Alejandro Ramirez, München (DE); Corina Kim Schindhelm, München (DE)

(21) Appl. No.: 15/767,454

(22) PCT Filed: Aug. 17, 2016
(86) PCT No.: PCT/EP2016/069461

§ 371 Date: Apr. 11, 2018

(30) Foreign Application Priority Data
Oct. 13, 2015 (DE) 10 2015 219 836.7

(51) Int. Cl. G01C 21/20; G01S 5/02; G01S 19/49

(52) U.S. Cl. CPC G01C 21/206; G01S 19/49; G01S 5/0294; G01S 5/0263

(57) ABSTRACT

The disclosure relates to a method for determining an indoor position of a moving object. The method includes using a first location determination method for determining first position data; using at least a second location determination method for determining second position data; and deriving a position of the moving object by combining first and second position data gathered from both systems.

The present patent document is a § 371 nationalization of PCT Application Serial Number PCT/EP2016/069461, filed Aug. 17, 2016, designating the United States, which is hereby incorporated by reference, and this patent document also claims the benefit of DE 10 2015 219 836.7, filed Oct. 13, 2015, which is also hereby incorporated by reference.

### TECHNICAL FIELD

The disclosure relates to a method, a device, and a system or determining an indoor position of a moving object.

### BACKGROUND

Indoor positioning offers the possibility of locating users in an indoor environment, e.g., inside buildings. Thus, e.g., targeted advertising, navigation, rescue services, healthcare monitoring, etc. are facilitated.

Different approaches are known, amongst them radio frequency (RF) based techniques such as the following techniques.

In one technique, received signal strength indicator (RSSI)—non distance based calculations, which are also referred to as “fingerprinting”, are used. This method includes performing a series of RSSI measurements of existing RF platforms, (e.g., WiFi, Bluetooth, etc.) at the site, (e.g., in the building), at specific positions and storing the measurements in a database, along with the geographical information of where each of these measurements was taken, in a calibration act. On run time, a device measures these parameters again and compares them to the ones stored on site. Afterwards, depending on some metric, it calculates its position. This method requires extensive calibration in order to establish a series of RSSI measurements paired with their geographical location.

In another technique, a RSSI—distance based calculations is used. The RSSI method may be used to determine approximately how much distance has a signal travelled using path loss equations, where the relationship between distance and signal loss may be configured to the specific surroundings. These approximate how much strength an RF signal loses due to the distance it travels and with this it is possible to perform geometrical trilateration using three or more different RF sources. In principle, if the transmitter's location is known before hand, there is no need to perform calibration.

In another technique, Time of Arrival (ToA)—distance based calculations are used. The technique uses the timestamps from packets between a device and an access point to a network, (e.g., a WLAN), wherein it is possible to determine the distance traveled using the known travel velocity for RF signals, (e.g., the speed of light). Then, similarly to the previous technique, geometric trilateration may be performed. As with the previous technique, if the transmitter's location is known, no calibration is needed.

Further, non-RF based techniques are known.

One example of a non-RF based technique is imaging and image recognition, where a series of pictures of a location are taken and stored in a database along with the geographical information of where each of these was taken, in a calibration act. On run time, new pictures taken at the location that needs to be determined are compared to those stored in the database and a best match is found. This technique may be considered as visual fingerprinting and as such requires extensive calibration before use.

Another example includes ultrasound—distance based calculations, where ultrasound waves may be used to detect obstacles depending on the time it takes them to bounce back from said obstacles. This time may then be used, along with the speed of sound, to calculate the distance to an obstacle.

Another example of a non-RF based technique is inertial positioning, also known as “dead reckoning”, wherein the systems constantly estimate an object's location based on a known initial position and a series of real time readings from inertial sensors such as accelerometers, gyroscopes, and magnetometers.

It is one object of the disclosure to offer a possibility to effectively locate moving objects in indoor environments.

### BRIEF SUMMARY

The scope of the present disclosure is defined solely by the appended claims and is not affected to any degree by the statements within this summary. The present embodiments may obviate one or more of the drawbacks or limitations in the related art.

The disclosure relates to a method where an indoor position of a moving object is derived by combining first and at least second position data. The first or second location data stem from a first or second location determination method respectively.

Thus, by combining data from two different methods, accuracy is enhanced.

Location determination is also referred to as positioning or locating. An indoor position refers to a position within closed surroundings, (e.g., inside of buildings, other premises or underground). Additionally, an indoor position denotes a position where there is no GPS or similar signal available; however, there are limitations of the space the moving object is in.

According to an advantageous embodiment, the first location method is calibrated and is accurate for a first time period after calibration.

According to another advantageous embodiment, the second location data stem from a second location determination method that is very accurate on a short-time basis but requires calibration often. In particular, the second location data is stable only during a second time period.

According to a further embodiment, the exact length of the time period may be depending also on the speed of the moving object. In particular, the second time period may be shorter than the first time period.

According to an advantageous embodiment, a combination of two position determination methods is performed, one method of which is accurate and requires a one-time high calibration effort due to movement in the environment, (e.g., Bluetooth signal-based positioning), wherein the second method requires constant calibration making it very accurate in the short term, but inaccurate on the long term. Through this, advantages of one system are used to cover the disadvantages of another. In addition, the first positioning method, (e.g., Bluetooth signal-based positioning), is used to constantly recalibrate the other system. Thus, no manual calibration of the other system, based, e.g., accelerometer, gyroscope, and magnetic sensor data providing, e.g., data in regard to step count or/and orientation, is required.

In particular, at least one further location determination method providing further position data is used for deriving the position of the moving object. This further enhances position detection accuracy.

The disclosure further relates to a corresponding device for determining an indoor position. The device includes interfaces for receiving corresponding positioning data or/and transferring data to a computational device SE. In particular, this may be an internal interface within the device. Alternatively, or additionally via the latter interface, data may be transferred to an external computational device, e.g., a server SE accessible via a network.

In particular, the device may be a portable computer having the corresponding sensors and interfaces, on which a computer program may be run for performing a positioning method which position measurement from different positioning methods.

The disclosure further relates to a system including a respective device and at least one radio beacon wherein the method may be performed.

The disclosure also relates to a computer program and a data carrier for storing said computer program.

### BRIEF DESCRIPTION OF THE DRAWINGS

Further embodiments, features, and advantages of the present disclosure will become apparent from the subsequent description and claims, taken in conjunction with the accompanying drawings.

FIG. 1 depicts an exemplary embodiment of a system including a device for performing a location method and radio beacons.

FIG. 2 depicts an exemplary embodiment of data handling and processing.

FIG. 3 depicts a schematic concept of a particle filter used to shape data obtained by measurements.

### DETAILED DESCRIPTION

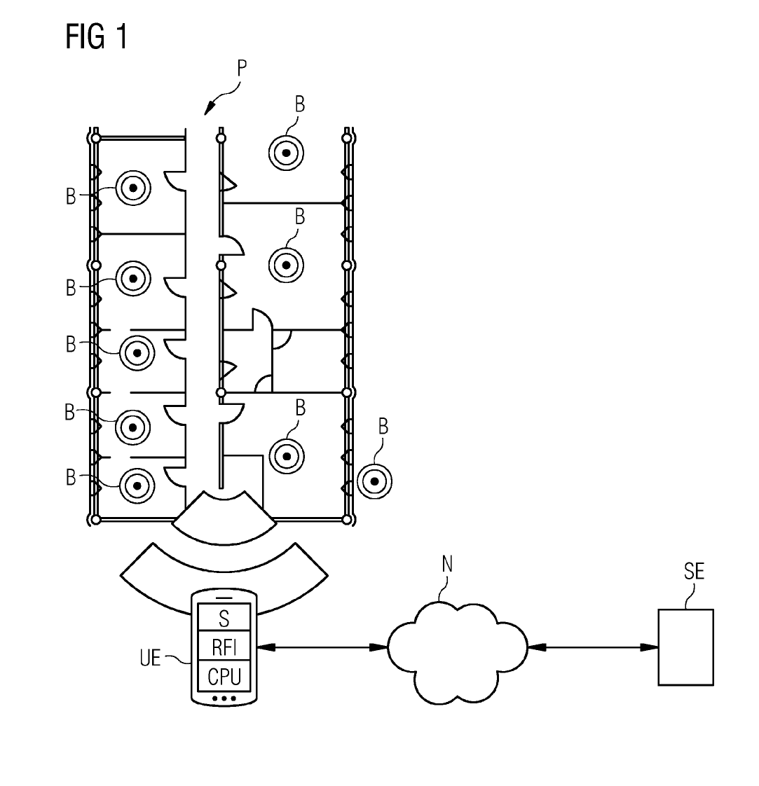

In the embodiment of a system architecture shown in FIG. 1, a number of Bluetooth Low Energy (BLE) beacons B are positioned in selected locations in an indoor environment, (e.g., inside of rooms), as shown on the floor plan.

The beacons B may be located at central positions, such as the position where the lamp is mounted. Alternatively, or additionally, the beacons B are mounted at position where the necessary infrastructure such as power supply is already available.

Both the beacon locations and respective unique identifiers such as Medium Access Control (MAC) addresses are stored. The locations and unique identifiers may be stored in a database and related to each other, e.g. in view of position, distance, etc. The precise whereabouts of the beacons B, as well as the layout of the respective floor or floor plan of the location, (e.g., of the premises P depicted in FIG. 1), are known. If they are known, no calibration for the first position detection method is required. Alternatively, according to another embodiment, a calibration may be performed.

Each beacon B broadcasts a distinct MAC address that is associated with its location. Alternatively, or additionally, the beacons send other information, which may be unique to each device, and thus may also be used for identification purposes.

However, RF transmissions suffer from a series of effects that are further exacerbated by indoor environments. One of these effects is multipath propagation, which is due to the fact that RF signals bounce of obstacles and arrive at the destination from different directions; this in turn produces effects such as constructive or destructive interference, e.g., the signal is strengthened or diminished by these reflections and phase shifting, e.g., signals arriving out of phase in regard to the signal that propagates directly. These effects may cause spikes in a signal's strength and therefore locations are wrongly reported when they are based only on the RF measurements, e.g., when using only beacons for location determination.

The signal strength may be very easy to obtain on any hardware platform, but at the same time is very unstable.

Therefore, for deriving a position of a moving object, position data gained by using a second positioning method is used in combination with the first position data based on RF measurements, e.g., BLE signals. Thus, a mechanism is introduced to stabilize those jumping positions derived from BLE signals. The position jumps due to the instability of the signal strength, and this stability is due to the reflections, refraction, diffraction, and absorption of the radio waves, which are part of the multipath situation. Also, the reported position will jump if the way of holding the device changes, as, e.g., the hand of the user may partially block the antenna.

By the second positioning method, the trajectory of a person is gathered while walking through the premise P.

According to an embodiment, this is achieved by a mobile application that detects the physical activity of a user, through the use of the inertial measurement unit (IMU) built into the mobile device, which may measure the acceleration of linear movement (e.g., 3D accelerometer), acceleration of the rotation (e.g., 3D gyroscope) and the magnetic field (e.g., 3D magnetometer). This IMU data may be used for step count determination, activity detection or to measure the covered distance. This mobile application is performed, at least partly on a mobile communication device UE, (e.g., a smartphone). To monitor these entities, the device, (e.g., the smartphone), may include embedded sensors S such as the accelerometer, magnetometer, barometer, gyroscope, light or/and audio sensors. The data output thereof is read and processed to produce both the real time step count or distance moved and the user's movement profile.

Further, the communication device UE may include RF interfaces RFI for data exchange via Bluetooth Low Energy (BLE), WiFi, or mobile communication standards.

The processing unit CPU of the mobile device is arranged such that data treatment algorithms may be employed, (e.g., such as Kalman filtering, moving average filtering, smoothing filtering, sensor fusioning, activity recognition algorithms).

The mobile device may communicate via a network N, (e.g., the interne or another wide area network (WAN)), with a server SE handling data D such as displayable maps and performs logic operations such as data retrieval, guarding privacy requirements.

A separation of where data is taken and computations are done may be made in this way. For example, data taking is handled by the mobile device UE and computations are performed at the Server SE having a much higher computational power. This may be useful if complex algorithms are used for determining a position, e.g., as particle filtering.

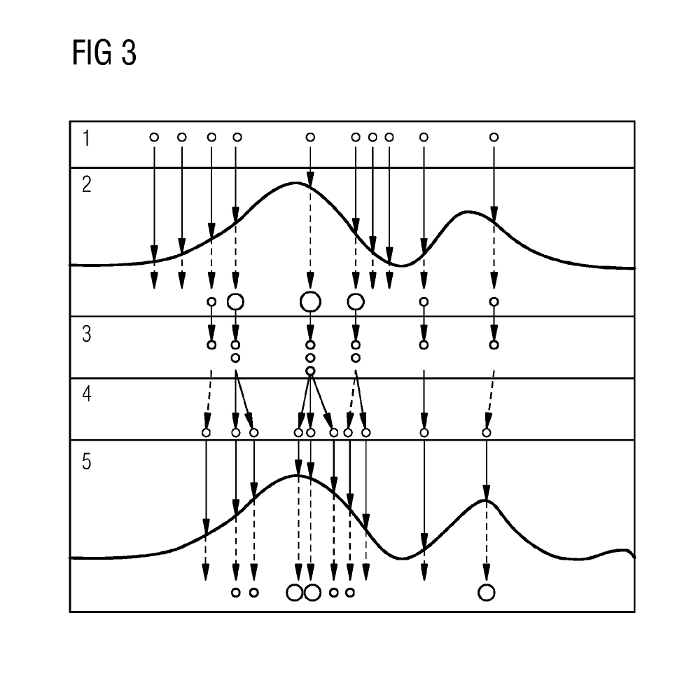

A further embodiment uses a “particle filter” in order to estimate the real value of the hidden variable by using the measurements from an available variable; this is called a hidden Markov model. In the above embodiments, the hidden variable would be the real position while the available variable is the noisy measurements obtained from the sensors and Bluetooth geo tagging. A particle filter algorithm includes the following concept of data treatment as may be seen in FIG. 3.

For a sample of “particles”, (e.g., data sets), obtained in act 1 from a phenomenon, for each particle or a subset of particles, an importance weight is computed in act 2. A higher probability of the data set being correct leads to a higher weight assigned. A re-sampling is performed according to the weights in act 3, after which, in act 4, the samples are moved according to the distribution. In act 5, a selection is performed according to importance weights. In other words, the particle filter generates an estimated probability distribution from the available measurement data and then produces a considerable number of “particles” from this distribution that are randomly displaced. Then the particles with the most statistical importance are kept.

As particle filtering requires a considerable amount of processing power. The filtering may be used in devices with a high processing power, thus all computations are performed onboard.

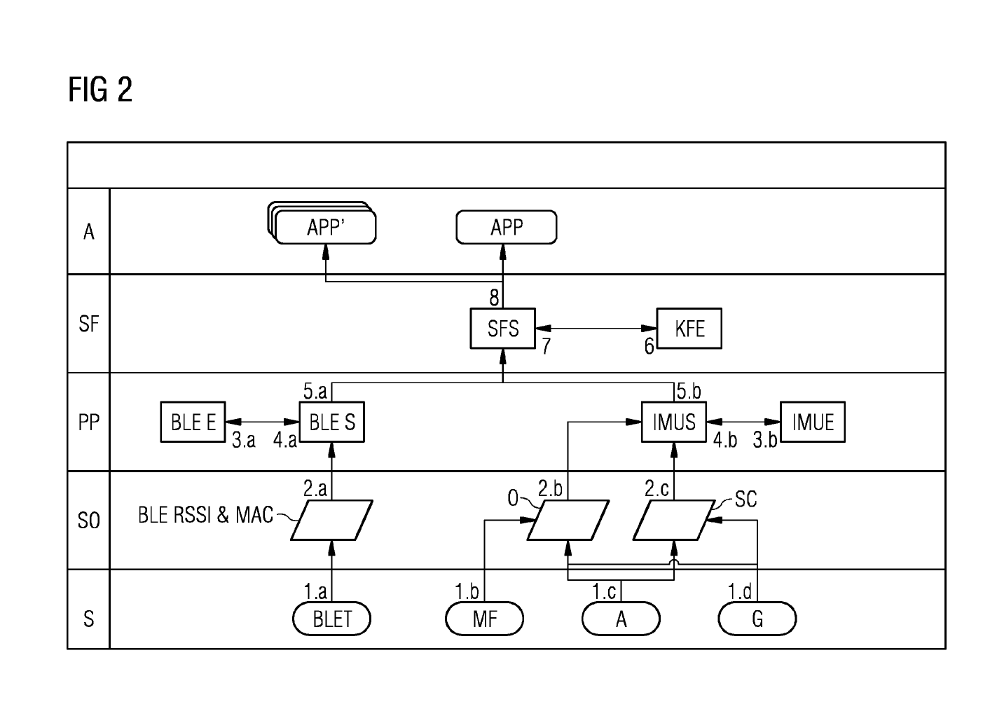

Alternatively, online processing may be applied. There, data is collected on the mobile device UE, (e.g., a phone), and uploaded to a remote server SE where the processing is done, (see FIG. 2).

According to a further embodiment, in order to make efficient use of combining data from two different positioning methods so called “sensor fusion algorithms” are used. By using sensor fusion algorithms, these sources of information may be used to pin point a user's location indoors with accuracy, which may be provided by the BLE geotagging and reliability, which may be provided by the activity recognition: BLE geotagging already provides room level accuracy, e.g., the existence in a certain room may be affirmed or denied. The further applied activity recognition helps to reduce the effects of RF propagation explained above and therefore increase reliability.

According to another embodiment, in order to fuse sensor information, as mentioned above, a Kalman filter is employed. The Kalman filter uses a series of noisy measurements obtained over time to estimate an unknown variable more precisely. For the modeling of this embodiment, the physical linear movement model to predict the system state in the next instant in time using the activity recognition data to update the geotagging position. After the state is predict, the Kalman filter then proceeds to correct it using the new measurement. The Kalman filter is well suited for the privacy protecting setting where all calculations are performed on the mobile device UE, (e.g., the smartphone).

Short term dead reckoning based activity recognition may provide fairly accurate real time position evolution.

However, all these inertial sources of information incur in intrinsic drift and as they keep being fused over time, without external calibration, the position estimates also drift away from the actual location. Unless very accurate motion sensors are used to measure motion, which may be rather expensive, calibration is repeatedly necessary.

One important aspect of the various embodiments is reducing calibration and thus installation efforts in indoor positioning systems as well as providing accuracy above room level. Current state of the art indoor positioning proposals tend to rely on extensive and invasive calibration efforts that entail both time to perform and quite possibly an interruption in the regular operations at the site. Therefore, it is one intention to remove or minimize the need for calibration. Calibration may represent the highest cost component in a location system, and the quality of the calibration will greatly determine its performance.

In FIG. 2, an exemplary embodiment depicts how data is handled and processed by using an application, in particular, an Android application run on a mobile device. Sensors S such as a BLE transceiver BLET, magnetic field sensor MF, accelerometer A, or gyroscope G provide in respective acts 1.a- 1.d sensor output data SO.

The output data SO include Bluetooth low energy RSSI or/and MAC data BLERSSI&MAC or/and other information such as universal unique identifier (UUDI) or/and major or/and minor from the BLE transceiver BLET as data from a first location method. Further the output data include orientation data 0 from the magnetic field sensor MF and accelerometer A and gyroscope G, and step count data SC from the gyroscope G and accelerometer as data from a second location method.

Alternatively, not all of these data are used or obtained from all shown sensors, but different combinations of sensors are used.

The output data SO is provided in acts 2.a-2.c to respective services used for communication, see acts 3a, 3.b and 4.a, 4.b with respective processing engines, a BLE engine BLEE and an inertial measurement unit (IMU) engine IMUE, for a pre-processing PP. In the example of FIG. 2, available Android services are used for data exchange with the processing engines, a BLE service BLES and an IMU service IMUS.

In the embodiment of FIG. 2, sensor fusion SF is performed by providing data in acts 5.a and 5.b to a sensor fusion service SFS, in particular provided by the operating system of the mobile device UE, (e.g., Android), where the data are transferred in act 6 to a Kalman filter engine KFE and the processed data are, in act 7, transferred back to the sensor fusion service SFS used for the exchange with the Kalman filter engine KFE.

In act 8, the thus transformed data are provided to a program A run on the mobile device UE.

Advantages of the described embodiments are the possible use of standard off-the-shelf hardware, such as standard smartphones and tablets running an Android operating system and which support with Bluetooth Low Energy (BLE). This opens a wide range of possible users, as a user interface may be installed on more devices than if special hardware was necessary.

A further important advantage is that it is easy to use as there is no need for calibration from the user and the interface may be designed similar already existing positioning services.

In addition, a high accuracy may be achieved. The initial BLE tagging system has a reported accuracy of about 1.4 m, the step detection accuracy is above about 95% of detected steps and the orientation measurement has lower than 1% variance. As such, the combination of these systems should provide an overall accuracy higher than previously existing systems.

Also, the reliability may be increased by using both sources of information. Thus, it will be possible to uniquely locate, without a doubt, where the user is at any given moment.

Further, in contrast to other systems the proposed embodiments require no in-field calibration at all. Other systems may require extensive fingerprinting or recording of a site, which may take hours and days depending on the size of the site, hence quite possibly interrupting day to day operations if not done properly.

A computer program or piece of software for use on a computer, in particular mobile computer, especially a smartphone initiates the gathering of information such as BLE tags being found and physical activity by activating the respective interfaces of the computer. Thus, the user needs to start only the, e.g., smartphone application without having to provide any further active input from the user.

In theory, BLE tags provide room level accuracy due to their low transmission power. The range of each BLE tag is somewhat limited to the room wherein it is located. This is due to the fact that going into another room with a different tag will cause the latter to be considered as the closest one. However, in practice, multipath phenomena explained before hinder this, which means that reflections of the signal make it very difficult to accurately define the location of a user.

Activity detection further allows for the determination of the true position or “stabilization of a fix”. Knowing where the user is going, and where the user came from, due to the user's activity and possibly a model representation of the floor plan, e.g. to know where doors and walls are, will allow to rule out computationally possible, but false candidates of the user's location or “ghost fixes”, which, e.g., moves the user's position through a wall). On the other hand, if a user is not moving, e.g., detected through activity recognition which uses the accelerometer, even though the position calculated through Bluetooth will show some movement, the combination with the acceleration sensor may deliver a static position.

Also, there is no need to perform invasive analysis on the desired location. Solutions according to the prior art need to perform imaging studies or RF fingerprinting, which are both invasive and time-consuming procedures that may cause interruptions of day to day operations. Further, imaging and fingerprinting require technicians to go to the site and perform extensive measurements of varying granularity which may take a long time and cause great inconvenience. The proposed embodiments allow for the tags to be deployed in a manner of minutes up to hours, depending on the floor plan, with minimum engagement of bystanders. After planning, the tags may be deployed easily.

As already mentioned, an important advantage is that, through the combination of two positioning method with different characteristics a higher accuracy than any other similar product on the market may be achieved, while at the same time expensive calibration efforts may be avoided.

According to another embodiment, the system may be integrated as a platform for Context Aware Industrial Automation providing industry operators with context aware technology that displays only the necessary information depending on the user's location.

Another embodiment in the context of industry environment lies in safety automation for large machinery; machinery may be made aware of operations in its vicinity and suspend its operation were one to come too close to it, thus preventing possibly fatal accidents.

According to a further embodiment, one or more embodiments above are integrated with existing mapping platforms to allow for a global indoor positioning system. The main advantage in regard to existing systems is the lack of calibration, low deployment efforts and the passive behavior of the application, e.g., that no user effort is required. Other solutions may require extensive measurement phases and require the user to perform actions such as taking a picture of their environment.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for determining an indoor position of a moving object, the method comprising:
determining first position data using a first location determination method;
determining second position data using at least a second location determination method; and
deriving a position of the moving object by combining the first position data and the second position data.

2. The method of claim 1, wherein the first location determination method provides a high accuracy for at least a predetermined first time span,
wherein the second location determination method provides a high accuracy for a second time span, and
wherein the second time span is shorter than the first time span, or/and
wherein a calibration of the second location determination method is performed by using data from the first location determination method.

3. The method of claim 1, wherein the first location determination method is based on radio signals.

4. The method of claim 1, wherein the second location determination method is based on a trajectory determination of the moving object.

5. The method of claim 4, wherein trajectory detection signals from at least one of the following sensors are used: a step count detector; an accelerometer; a magnetometer; gyroscope; a light sensor; and an audio sensor.

6. claims The method of claim 1, wherein the deriving of the position of the moving object comprises:
transmitting at least one of the first position data or second position data to a computational device for performing computational complex operations;
receiving the transformed position data; and
deriving the position of the moving object.

7. The method of claim 1, wherein a Kalman filter is used when combining the first position data and the second position data.

8. The method of claim 1, wherein a particle filter is applied for treatment of the first position data, the second position data, or both the first position data and the second position data.

9. The method of claim 1, wherein at least one further location determination method providing further position data is used for the deriving of the position of the moving object.

10. A device for determining an indoor position of a moving object, the device comprising:
a first interface configured to receive first position data from a first location determination method;
a second interface configured to receive second position data from a second location determination method; and
a third interface for transmitting data from or to a computational device, which is arranged such that a position of a moving object is derived by combining the first position data and the second position data.

11. The device of claim 10, wherein the third interface is a device internal interface to a device processing unit or is an interface to an external computational device.

12. The device of claim 10, wherein the device is a portable computer.

13. A system comprising:
a radio beacon configured to provide a radio signal; and
a device for determining an indoor position of a moving object, wherein the device comprises:
a first interface configured to receive first position data from a first location determination method, wherein the first location determination method is based on the radio signal from the radio beacon;
a second interface configured to receive second position data from a second location determination method; and
a third interface for transmitting data from or to a computational device, which is arranged such that a position of a moving object is derived by combining the first position data and the second position data.

14.-15. (canceled)

16. The method of claim 2, wherein the data for the calibration is the first position data.

17. The method of claim 3, wherein the radio signals are low energy Bluetooth signals.

18. The method of claim 4, wherein the trajectory determination of the moving object comprises a combination of a distance determination method and an orientation determination method.

19. The device of claim 11, wherein the interface is an interface for wireless transmission over the Internet.

20. The device of claim 12, wherein the portable computer is a smartphone or a smart watch.
